(19) United States
(12) Patent Application Publication
(10) Pub. No.: US 2025/0007301 A1
(43) Pub. Date: Jan. 2, 2025

(54) CONTROL CIRCUIT OF ENERGY STORAGE SYSTEM, METHOD, AND ENERGY STORAGE SYSTEM

(71) Applicant: EVE ENERGY CO., LTD., HUIZHOU (CN)

(72) Inventors: WENBING XIAO, HUIZHOU (CN); ZHEN LIU, HUIZHOU (CN); LIPING WAN, HUIZHOU (CN); SHAOWEI XIE, HUIZHOU (CN); HENG CAI, HUIZHOU (CN)

(21) Appl. No.: 18/757,530

(22) Filed: Jun. 28, 2024

(30) Foreign Application Priority Data
Jun. 30, 2023 (CN) 202310795655.1
Jun. 30, 2023 (CN) 202310802285.X
Jun. 30, 2023 (CN) 202321701876.X
Jun. 30, 2023 (CN) 202321712965.4
Mar. 1, 2024 (WO) PCT/CN2024/070528

(51) Int. Cl. H02J 7/00

(52) U.S. Cl. CPC H02J 7/0025; H02J 7/00041; H02J 7/007182; H02J 7/007194; H02J 2207/20

(57) ABSTRACT

A control circuit of an energy storage system includes a cell module, a control module, and a commutating module, which are connected in sequence. The cell module includes n modularized cell control units. Each modularized cell control unit includes a cell, a first switch, and a second switch; the cell and the first switch are connected in series and then connected in parallel with the second switch. A first switch and a second switch of the first cell are connected to serve as a first end of the cell module, and the n-th cell and the n-th second switch are connected to serve as a second end of the cell module. The control module is communicatively connected with the modularized cell control unit and the commutation module. The control module is configured to control switches of the commutating module to be switched on or off.

### CROSS REFERENCE TO RELATED APPLICATIONS

The present application claims priorities of the Chinese patent application No. 202310802285.X, filed on Jun. 30, 2023; the Chinese patent application No. 202321712965.4, filed on Jun. 30, 2023; the Chinese patent application No. 202310795655.1, filed on Jun. 30, 2023; the Chinese patent application No. 202321701876.X, filed on Jun. 30, 2023; and the international patent application No. PCT/CN2024/070528, filed on Mar. 1, 2024. Contents of which are incorporated herein by their entireties.

### TECHNICAL FIELD

The present disclosure relates to the field of power supply circuits, and in particular to a control circuit of an energy storage system, a method, and an energy storage system.

### BACKGROUND

In the art, a lithium-battery energy storage system substantially consists of a battery system and a power conversion system (PCS). The PCS takes the power electronic technology to achieve conversion between a battery direct current (DC) voltage and a grid alternate current (AC) voltage. The PCS controls the battery system to be charged and to discharge, performs AC-DC conversion, and directly supplies power for AC loads and when the grid is unavailable. In the battery system, 15 s or 16 s cells are connected to each other in series to form a battery module, a plurality of battery modules are connected to each other in series to form a battery pack, and a plurality of battery packs are connected to each other in series to form a battery cluster. When a desired high voltage is formed by the in-series connections, energy interaction with the AC grid is performed through the PCS. In addition, a slave control unit of a battery management system (BMS) is arranged inside the battery module or the battery pack, and a master control unit of the BMS is arranged inside the battery cluster and configured to manage the battery system.

However, as a capacity and a size of the cell is increasingly larger, each individual cell is large and heavy. In this case, if the plurality of cells are connected in series to each other to form the battery module, the battery module may be large and may have a weight of several hundred kilograms. Therefore, the battery modules may not be assembled easily. In addition, since the BMS and the PCS have a large amount of costs, the PCS may be large, costs of the energy storage system may be high, and a new cell may not be used in combination with original cells.

### SUMMARY OF THE DISCLOSURE

In a first aspect, the present disclosure provides a control circuit of an energy storage system, including: a cell module, a control module, and a commutating module, wherein, the cell module, the control module and the commutating module are connected in sequence.

The cell module includes n modularized cell control units, each modularized cell control unit comprises a cell, a first switch and a second switch; the cell and the first switch are connected to each other in series, and are further connected in parallel to the second switch; the n is a positive integer.

A first switch and a second switch of a first modularized cell control unit of the n modularized cell control units are connected to each other to serve as a first end of the cell module; a first switch and a second switch of an n-th modularized cell control unit of the n modularized cell control units are connected to each other to serve as a second end of the cell module.

The commutating module comprises a first commutating switch, a second commutating switch, a third commutating switch, a fourth commutating switch and a filter unit; the filter unit comprises a first end, a second end and a third end; the first end of the cell module is connected with a first end of the first commutating switch and a first end of the third commutating switch; a second end of the first commutating switch is connected with the first end of the filter unit; a second end of the third commutation switch is connected to the third end of the filter unit; the second end of the cell module is connected to a first end of the second commutating switch and a first end of the fourth commutating switch; the second commutating switch is connected to the first end of the filter unit; a second end of the fourth commutating switch is connected to the third end of the filter unit; an alternating current (AC) grid is connected between the second end of the filter unit and the third end of the filter unit.

The control module is communicatively connected to the modularized cell control units and the commutating module; the control module is configured to control the first commutating switch, the second commutating switch, the third commutating switch and the fourth commutating switch to be switched on or switched off.

In a second aspect, the present disclosure provides a control method of an energy storage system, including:
detecting a voltage of an alternating current (AC) grid;
calculating, based on the voltage of the AC grid and a voltage of a series circuit of cells, a phase angle between the grid voltage and a circuit voltage;
determining an operation mode of the energy storage system, wherein the operation mode comprises a discharging mode and a charging mode;
performing, by a control module, a closing-cutting operation by following a first preset control strategy, in response to the energy storage system being in the charging mode and the phase angle between the grid voltage and the circuit voltage meeting a preset condition; and
performing, by the control module, the closing-cutting operation by following a second preset control strategy, in response to the energy storage system being in the discharging mode and the phase angle between the grid voltage and the circuit voltage meeting the preset condition.

In a third aspect, the present disclosure provides an energy storage system, including an n-stage in-series-connected modularized cell control unit. The modularized cell control unit comprises an external connection end, a cell, a temperature detection circuit, a cell micro-control module, a cell voltage detection circuit, a communication circuit, and a switch switching module; and the n is a positive integer.

The cell is electrically connected to the external connection end via the switch switching module; the switch switching module is configured to control the cell to be connected to or disconnected from the energy storage system.

The temperature detection circuit is electrically connected to the cell and the cell micro-control module, the temperature detection circuit is configured to detect a temperature of the cell and to send the temperature to the cell micro-control module.

The cell voltage detection circuit is connected in series between the cell and the cell micro-control module, the cell voltage detection circuit is configured to detect a voltage of the cell and to send the voltage to the cell micro-control module.

The communication circuit is communicatively connected to the cell micro-control module, the communication circuit is configured to perform information interaction between the modularized cell control unit and a superior control unit.

The cell micro-control module is further electrically connected to the switch switching module, the cell micro-control module is configured to control the switch switching module based on the temperature, the voltage and/or the information interacted with the superior control unit.

### BRIEF DESCRIPTION OF THE DRAWINGS

FIG. 1 is a circuit diagram of a control circuit of an energy storage system according to some embodiments of the present disclosure.

FIG. 2 is another circuit diagram of a control circuit of an energy storage system according to some embodiments of the present disclosure.

FIG. 3 is a flow chart of conversion between an alternating current and a direct current according to some embodiments of the present disclosure.

FIG. 4 is a flow chart of a cell closing-cutting algorithm according to some embodiments of the present disclosure.

FIG. 5 is a schematic view of a voltage waveform according to some embodiments of the present disclosure.

FIG. 6 shows waveforms of an inductive reactive power and a capacitive reactive power according to some embodiments of the present disclosure.

FIG. 7 shows another waveforms of the inductive reactive power and the capacitive reactive power according to some embodiments of the present disclosure.

FIG. 8 shows still another waveforms of the inductive reactive power and the capacitive reactive power according to some embodiments of the present disclosure.

FIG. 9 shows still another waveforms of the inductive reactive power and the capacitive reactive power according to some embodiments of the present disclosure.

FIG. 10 is a topological diagram of a three-phase energy storage system according to some embodiments of the present disclosure.

FIG. 11 shows waveforms of voltages of the three-phase energy storage system according to some embodiments of the present disclosure.

FIG. 12 is a structural schematic view of a modularized cell control unit according to some embodiments of the present disclosure.

FIG. 13 is a circuit diagram of the modularized cell control unit according to some embodiments of the present disclosure.

FIG. 14 is a flow chart of a control method of the energy storage system according to some embodiments of the present disclosure.

FIG. 15 is a structural schematic view of the energy storage system according to some embodiments of the present disclosure.

FIG. 16 is a structural schematic view of another energy storage system according to some embodiments of the present disclosure.

### DETAILED DESCRIPTION

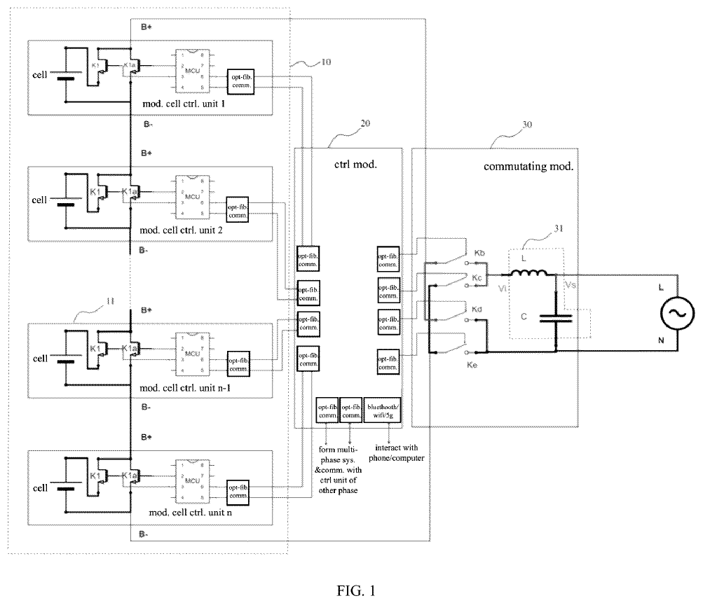

FIG. 1 is a circuit diagram of a control circuit of an energy storage system according to some embodiments of the present disclosure. As shown in FIG. 1, the present embodiment provides a control circuit of an energy storage system. The control circuit of the energy storage system includes: a cell module 10, a control module 20, and a commutating module 30. The cell module 10, the control module 20, and the commutating module 30 are connected sequentially. The cell module 10 includes n modularized cell control units 11. Each modularized cell control unit 11 includes a cell, a first switch, and a second switch. The cell and the first switch are connected to each other in series, and the in-series connected cell and first switch are in parallel connected with the second switch. The n is a positive integer. The first switch of a first cell control unit 11 of the n modularized cell control units 11 and the second switch of the first cell control unit 11 of the n modularized cell control units 11 are connected to each other to serve as a first end of the cell module 10. An n-th switch of an n-th cell control unit 11 of the n modularized cell control units 11 and an n-th second switch of an n-th cell control unit 11 of the n modularized cell control units 11 are connected to each other to serve as a second end of the cell module 10. The commutating module 30 includes a first commutating switch Kb, a second commutating switch Kc, a third commutating switch Kd, a fourth commutating switch Ke, and a filter unit 31. The filter unit 31 includes a first end 311, a second end 312 and a third end 313. The first end of the cell module 10 is connected to a first end of the first commutating switch Kb and a first end of the third commutating switch Kd. A second end of the first commutating switch Kb is connected to the first end 311 of the filter unit 31. A second end of the third commutating switch Kd is connected to the third end 313 of the filter unit 31. A second end of the cell module 10 is connected to a first end of the second commutating switch Kc and a first end of the fourth commutating switch Ke. The second commutating switch Kc is connected to the first end 311 of the filter unit 31. A second end of the fourth commutating switch Ke is connected to the third end 313 of the filter unit 31. An alternating current (AC) power grid is connected between the second end 312 of the filter unit 31 and the third end 313 of the filter unit 31. The control module 20 is communicatively connected to the modularized cell control unit 11 and the commutating module 30. The control module 20 is configured to control the first commutating switch Kb, the second commutating switch Kc, the third commutating switch Kd, and the fourth commutating switch Ke to be switched on or switched off.

Specifically, the cell module 10 includes n modularized cell units 11. A power conversion system (PCS) may be the filter unit 31. The cell may be a module of any cell combination. A B− of one modularized cell control unit 11 is connected to a B+ of a following cell control unit 11, and a B+ of the one modularized cell control unit 11 is connected to a B− of a previous cell control unit 11. A B+ of a cell control unit 11 at the beginning end is connected to the commutating unit, and a B− of a cell control unit 11 at the terminating end is connected to the commutating module 30. When an energy storage system is formed and is connected to the grid, the number of modularized cells is limited by a voltage of the grid. Taking a 230V grid as an example, the number of in-series connected modularized cells=230V×1.1×1.414/2.5V=144. Therefore, for the 230V grid system, at least 144 modularized cell units 11 are needed to be in-series connected to each other.

The control module 20 interacts information with the modularized cell control units 11 via optical fiber communication. The control module 20 drives, via an optical fiber, the first commutating switch Kb, the second commutating switch Kc, the third commutating switch Kd, and the fourth commutating switch Ke to be switched on or switched off. One control module 20 may communicate with another control module 20 via the optical fiber. In some embodiments, the control module 20 may interact with external mobile devices, such as mobile phones and computers, via Bluetooth, 5G or WIFI modules.

The commutating module 30 includes a commutating control unit and the filter unit 31. The commutating control unit is configured to commutate a half-wave sinusoidal voltage. The filter unit 31 is configured to smooth and filter a stepped wave of the cell. The commutating control unit includes four power switching transistors. The filter unit 31 includes an LC filter device. The filter unit 31 may be formed by any combination of LC, LCL, and other filter circuits according to the demands. FIG. 1 exemplarily shows that the filter unit 31 includes an inductor L and a capacitor C. The inductor L and the capacitor C form an AC output filter circuit to enable an AC output voltage to be smoother. The first commutating switch Kb, the second commutating switch Kc, the third commutating switch Kd, the fourth commutating switch Ke, the n first switches, and the n second switches are high-power switching devices in a same type. The high-power switching device may withstand high voltages and may be switched on and off by isolated driving. For example, the high-power switching device may be any one of MOSFET, IGBT, SCR, SiC, GaN.

An operating principle of the energy storage system is as follows. The modularized cell control unit 11 collects a temperature and a voltage of the respective cell and uploads the temperature and the voltage to an external control board via the optical fiber communication. The external control board sends commands to each modularized electric cell unit 11 via optical fiber communication, according to certain algorithms, and based on the data collected from each cell and a state of the power grid, such that the corresponding first switch K1 and the second switch K1a are controlled to be switched on or off, so as to determine whether or not the corresponding cell is connected in series in the energy storage system.

An operating principle of bypassing a failed cell is as follows. When one cell fails, the corresponding modularized cell unit 11 switches off the first switch K1 that is in-series connected with the failed cell, and switches on the second switch K1a that is in-parallel connected with the failed cell. In this way, the failed cell is bypassed, and the normal operation of the system is not affected. In this case, the modularized cell control unit 11 fast flashes a LED to inform the staff that the corresponding cell is failed, and the failed cell may be replaced in time.

In the present disclosure, the control circuit and the cell are integrated to form one module to form the energy storage system. The product may be modularized and standardized, such that assembling and wiring arrangement may be performed easily, the energy storage system may be formed by omitting a separate BMS and a separate PCS. Therefore, the energy storage system may be small in size have a quite low overall cost. A bus capacitor in the traditional PCS is eliminated, such that the size is reduced. A filter is unlike the traditional PCS and does not need to be large, the cost and the size are further reduced. The control circuit may bypass a faulty cell off, without affecting a normal operation of the energy storage system, such that the utilization rate of the energy storage system is improved, and the yield is increased. Since a high-voltage cell is firstly used during discharging and a low-voltage cell is firstly used during charging, an additional BMS is not required to control cells. Therefore, costs for the BMS may be reduced. The cell may be connected in series into the system circuit based on a certain algorithm, and new cells and original cells may be used in combination, such that the utilization rate of the energy storage system is improved, and the yield is increased. Therefore, the present disclosure solves the technical problem that the PCS is large, costs of the energy storage system is high, and the new cell is unable to be used in combination with original cells.

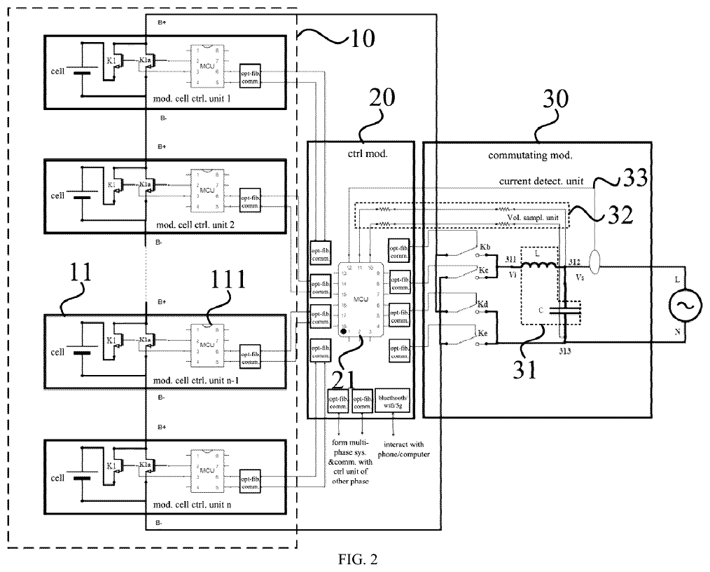

FIG. 2 is another circuit diagram of the control circuit of the energy storage system according to some embodiments of the present disclosure. As shown in FIG. 2, the modularized cell control unit 11 further includes a cell sampling chip 111. The control module 20 further includes a master controller 21. Cell sampling chips 111 of n modularized cell control units 11 are communicatively connected to the n cells and to the master controller 21. The cell sampling chips 111 are configured to collect voltages and temperatures of the n cells and send the voltages and temperatures to the master controller 21. The master controller 21 is communicatively connected to the first commutating switches Kb, the second commutating switch Kc, the third commutating switch Kd, and the fourth commutating switch Ke. The master controller 21 is configured to analyze and calculate the received voltages and temperatures and to control the n first switches, the n second switches, the first commutating switch Kb, the second commutating switch Kc, the third commutating switch Kd, and the fourth commutating switch Ke to be switched on or switched off.

Specifically, the cell sampling chip 111 may be a microcontroller unit (MCU). The MCU is substantially configured to collect the voltage and the temperature of the respective cell. The master controller 21 collects a total voltage of the cell module 10 to dynamically monitor the total voltage of the cell module 10. The master controller 21 generates a certain control timing according to data of the total voltage and to achieve conversation from AC to DC and conversation from DC to AC by controlling the switches to be switched on and off. The master controller 21 controls the n first switches and the n second switches to be switched on and off; performs data analysis and algorithmic calculation. The master controller 21 may be a single MCU, which may simplify the circuit structure and reduces costs; or may include a plurality of MCUs, which may increase a data processing rate, improving an operation efficiency.

Further in FIG. 2, the commutating module 30 further includes a voltage sampling unit 32 and a current detection unit 33. A first end of the voltage sampling unit 32 is connected to an eleventh end of the master controller 21, and a second end of the voltage sampling unit 32 is connected to a tenth end of the master controller 21. A third end of the voltage sampling unit 32 is connected to the second end 312 of the filter unit 31, and a fourth end of the voltage sampling unit 32 is connected to the third end 313 of the filter unit 31. A first end of the current detection unit 33 is connected to a twelfth end 12 of the master controller 21. A second end of the current detection unit 33 is connected to the second end 312 of the filter unit 31.

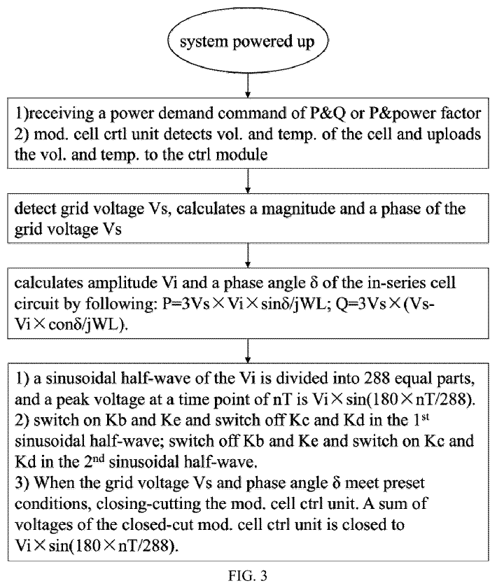

FIG. 3 is a flow chart of conversion between the alternating current and the direct current according to some embodiments of the present disclosure. As shown FIG. 3 an operation principle of the control circuit of the energy storage system is as follows.
1). The control circuit receives a power demand command from a user. The power demand command may be an active power P & a reactive power Q; or an active power P & a power factor.
2). The modularized cell control unit detects the voltage and the temperature of the cell and uploads the voltage and the temperature to the control module.
3). The grid voltage Vs is detected, and a magnitude and a phase of the grid voltage Vs are calculated.
4). An amplitude and a phase angle δ of the voltage Vi of the series circuit of the cells are calculated by following: P=3Vs×Vi×sin δ/jWL; Q=3Vs×(Vs−Vi×conδ/jWL). The phase angle δ is an angle between the grid voltage Vs and the voltage Vi of the series circuit of the cells.
5). A sinusoidal half-wave of the Vi is divided into 288 equal parts, and a peak voltage at a time point of nT is Vi×sin(180×nT/288).
6). When the grid voltage Vs and phase angle δ meet preset conditions, a closing-cutting operation is performed on the modularized cell control unit. A sum of voltages of the modularized cell control units that are closed-cut needs to be close to Vi×sin(180×nT/288).

To be noted that, various closing-cutting algorithms for the modularized cells are available. In an example, the closing-cutting algorithm is that, in a charging process, a cell having a low voltage is firstly charged; and in a discharging process, a cell having a high voltage is firstly discharged. In this example, in a charging mode, at a time point of 144T, a peak voltage is Vi×sin 90=Vi, voltages of cells are added up from a low voltage to a high voltage, until a sum that is approximately equal to Vi is obtained. Subsequently, the control unit sends commands to the modularized cell units to switch on the corresponding switches K1 and switch off the corresponding switches K1a. In this case, all of these cells are connected in series to the system circuit, and switches K1a of the remaining cells are switched on, and switches K1 of the remaining cells are switched off. In this case, the voltage of the entire system circuit is about equal to Vi. In this way, one stepped sinusoidal half-wave is formed between the time point IT and the time point 288T. A commutating operation is performed on a second sinusoidal half-wave to obtain the stepped sinusoidal waveform. Furthermore, the stepped sinusoidal waveform is treated by LC filtering, obtaining a smooth sinusoidal wave.

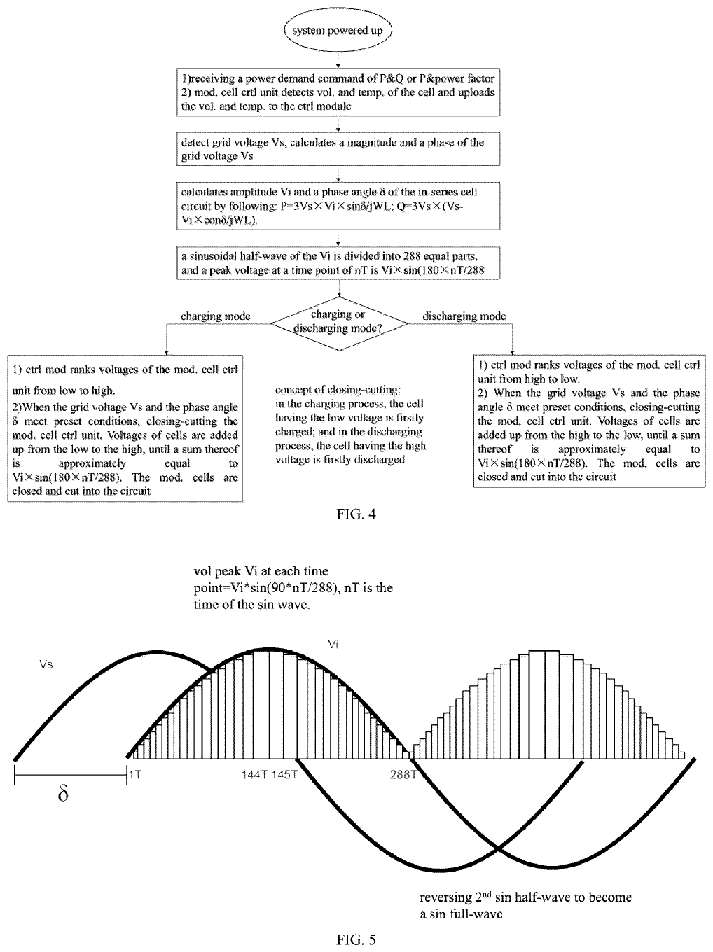

FIG. 4 is a flow chart of the cell closing-cutting algorithm according to some embodiments of the present disclosure. As shown in FIG. 4, a concept of closing-cutting cells is as follows: in the charging process, the cell having the low voltage is charged firstly; in the discharging process, the cell having the high voltage is discharged firstly.

When the energy storage system is in the charging mode, the control module 20 ranks voltages of the cells in the modularized cell control unit from a low value to a high value. When the grid voltage Vs and the phase angle δ meet preset conditions, the modularized cell units are closed and cut. Voltages of cells are added up from the low voltage to the high voltage, until the sum that is approximately equal to Vi×sin(180×nT/288) is obtained. Furthermore, the modularized cells are closed and cut into the circuit.

When the energy storage system is in the discharging mode, the control module 20 ranks voltages of the cells in the modularized cell control unit from the high value to the low value. When the grid voltage Vs and the phase angle δ meet preset conditions, the modularized cell units are closed and cut. Voltages of cells are added up from the high voltage to the low voltage, until the sum that is approximately equal to Vi×sin (180×nT/288) is obtained. Furthermore, the modularized cells are closed and cut into the circuit.

FIG. 5 is a schematic view of a voltage waveform according to some embodiments of the present disclosure. FIG. 5 exemplarily illustrates voltage waveforms when the cells are closed and cut in a single-phase energy storage system.

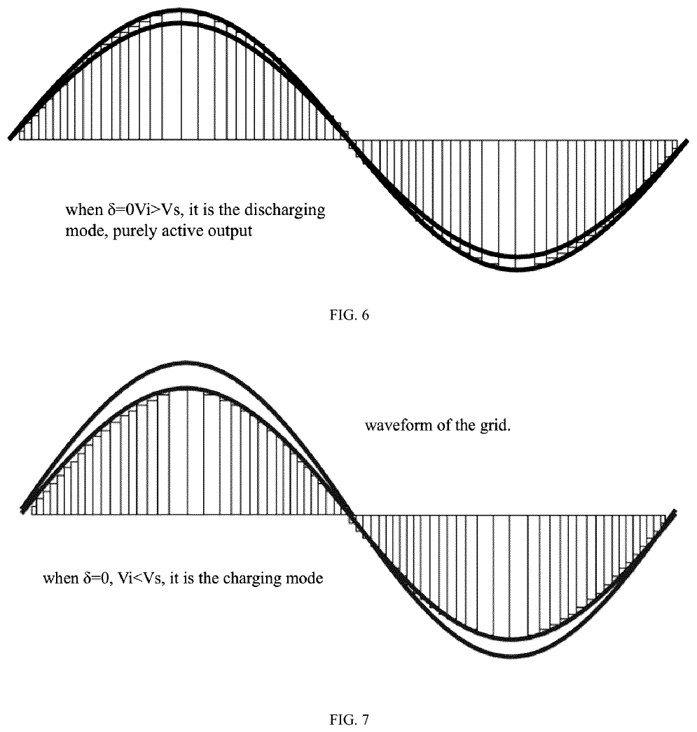

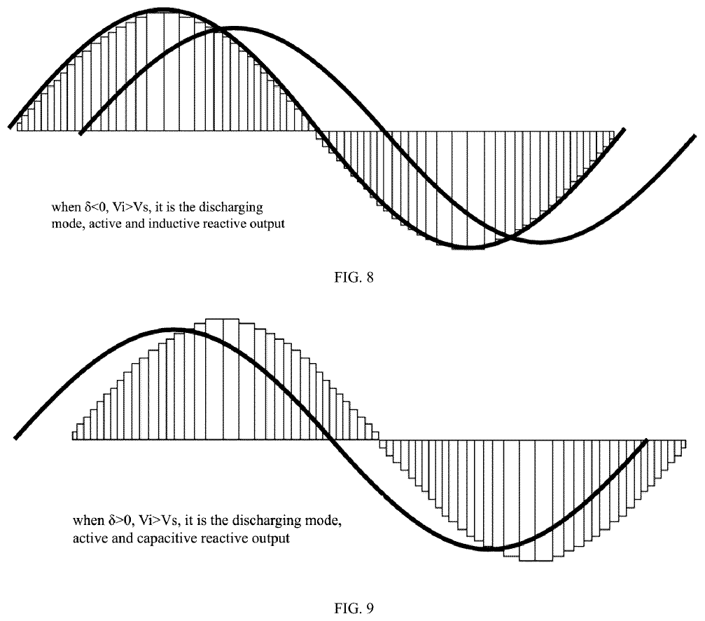

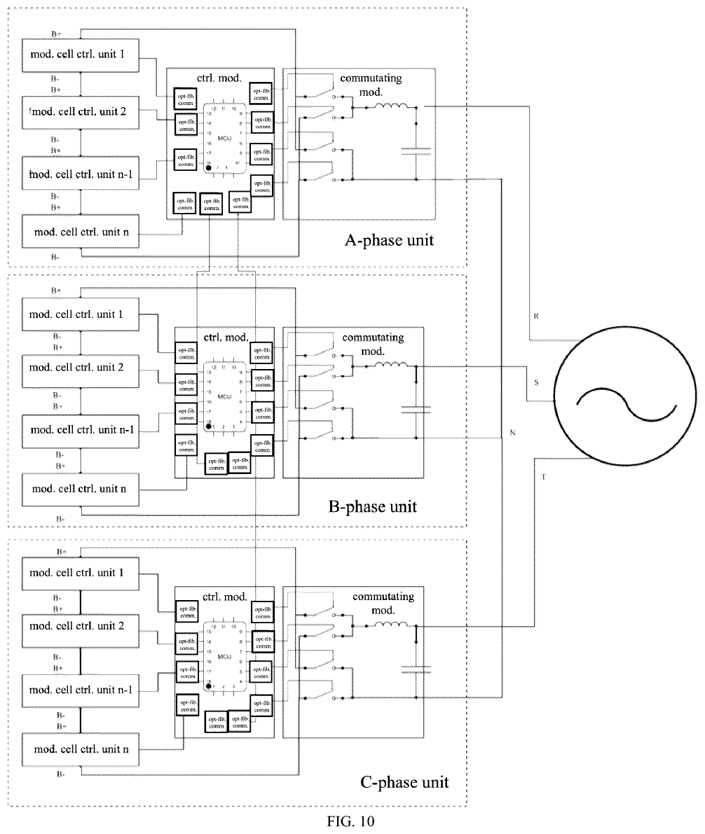

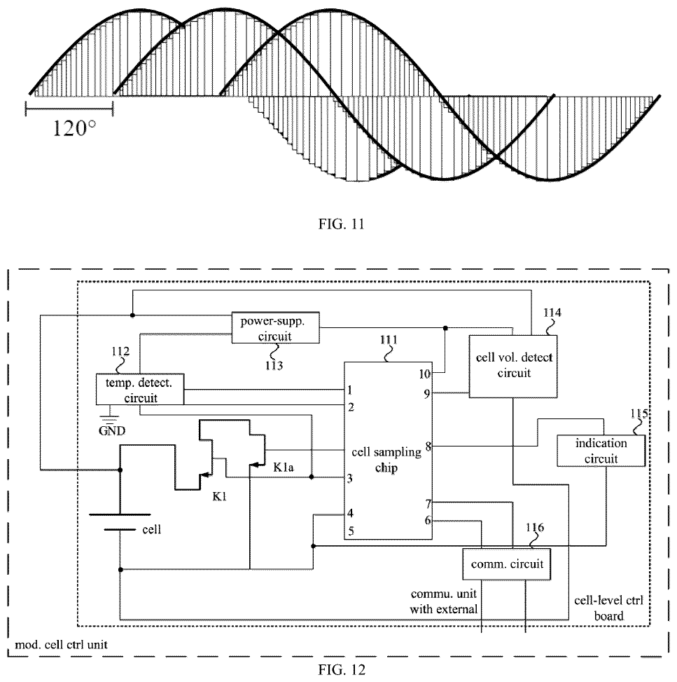

FIG. 6 shows waveforms of an inductive reactive power and a capacitive reactive power according to some embodiments of the present disclosure. FIG. 7 shows another waveforms of the inductive reactive power and the capacitive reactive power according to some embodiments of the present disclosure. FIG. 8 shows still another waveforms of the inductive reactive power and the capacitive reactive power according to some embodiments of the present disclosure. FIG. 9 shows still another waveforms of the inductive reactive power and the capacitive reactive power according to some embodiments of the present disclosure. As shown in FIG. 6, FIG. 7, FIG. 8, and FIG. 9, commands from the user controls the energy storage system to operate in a rectifier mode or an inverter mode, and operate at the inductive reactive power or the capacitive reactive power. The control module 20 calculates the Vi and the & value according to the commands, and waveforms of the inductive reactive power and the capacitive reactive power in the rectifier mode and in the inverter mode are shown in FIG. 6, FIG. 7, FIG. 8, and FIG. 9. FIG. 10 is a topological diagram of a three-phase energy storage system according to some embodiments of the present disclosure. FIG. 11 shows waveforms of voltages of the three-phase energy storage system according to some embodiments of the present disclosure. As shown in FIG. 10 and FIG. 11, an operation principle of the three-phase energy storage system is as follows. The three-phase energy storage system includes an A-phase unit, a B-phase unit, and a C-phase unit. A N wire of the A-phase unit, a N wire of the B-phase unit, and a N wire of the C-phase unit are connected to each other. Fire wires of the three phase units correspond to three-phase fire wires, R, S, and T, of the three-phase grid. The A-phase unit is a master control unit, and the control module 20 of the A-phase unit communicates with the other two phases through optical fiber communication. The master control unit controls the B-phase unit and the C-phase unit to have a phase angle of 120 degrees successively. Each phase is connected in series with corresponding cells into a circuit by following the operation principle of the single-phase energy storage system.

FIG. 12 is a structural schematic view of the modularized cell control unit according to some embodiments of the present disclosure. As shown in FIG. 12, the modularized cell control unit further includes: a temperature detection circuit 112, a power supply circuit 113, a cell voltage detection circuit 114, an indication circuit 115, and a communication circuit 116. A first end of the temperature detection circuit 112 is connected to the power supply circuit 113. A second end of the temperature detection circuit 112 is connected to a first end 1 of the cell sampling chip 111. A third end of the temperature detection circuit 112 is connected to a second end 2 of the cell sampling chip 111. A fourth end of the temperature detection circuit 112 is connected to a third end 3 of the cell sampling chip 111. A fifth end of the temperature detection circuit 112 is grounded (GND). A first end of the power supply circuit 113 is connected to a positive electrode of the cell. A second end of the power supply circuit 113 is connected to the voltage detection circuit 114. A first end of the cell detection circuit 114 is connected to a ninth end 9 of the cell sampling chip 111. A second end of the cell voltage detection circuit 114 is connected to the positive electrode of the cell. A third end of the cell voltage detection circuit 114 is connected to a negative electrode of the cell. A first end of the indication circuit 115 is connected to an eighth end 8 of the cell sampling chip 111. A second end of the indication circuit 115 is connected to a fourth end 4 of the cell sampling chip 111. A first end of the communication circuit 116 is connected to a sixth end 6 and a seventh end 7 of the cell sampling chip 111. A second end of the communication circuit 116 is communicatively connected to an external control unit.

Specifically, the cell is a high-capacity cell, having a large size and a large weight. The cell sampling chip 111 may be an MCU, and the first switch K1 is connected in series with the cell. The first switch K1 is controlled to be switched on and off by the MCU. The cell and the first switch K1 are connected in series to each other, and are further connected in parallel with the second switch K1a. The second switch K1a is controlled to be switched on and off by the MCU. The MCU is configured to receive the temperature of the cell collected by the temperature detection circuit 112 and the voltage of the cell detected by the cell voltage detection circuit 114. The MCU further uploads the received data to a cell-level control board through optical fiber communication. The cell-level control board may be communicatively connected with the control module 20 for data uploading and command receiving. The first switch K1 and the second switch K1a are controlled to be switched on and off according to the commands received by the cell-level control board. The MCU controls the indication circuit 115 to emit light or to light off according to the temperature and the voltage of the cell.

The temperature detection circuit 112 is configured to collect the temperature of the cell and send the temperature to the MCU. The power supply circuit 113 takes power directly from the cell and then converts the power to be 5V or 3.3V that is required by the MCU and other circuits. The cell voltage detection circuit 114 collects the voltage of the cell and sends the voltage to the MCU. The indication circuit 115 is configured to indicate an operation state of the modularized cell control unit. When the indication circuit 115 normally emits light, the modularized cell control unit operates normally. When the indication circuit 115 flashes, the modularized cell control unit fails. The communication circuit 116 includes an optic fiber terminal and an optic fiber communication chip and is configured to interact information with the control module 20. The cell-level control board may be disposed on a side of the cell or on a front side of an electrode. The location of the cell-level control board is determined based on actual situations, enabling the cell-level control board and the cell are configured into a one-piece structure to achieve modularity.

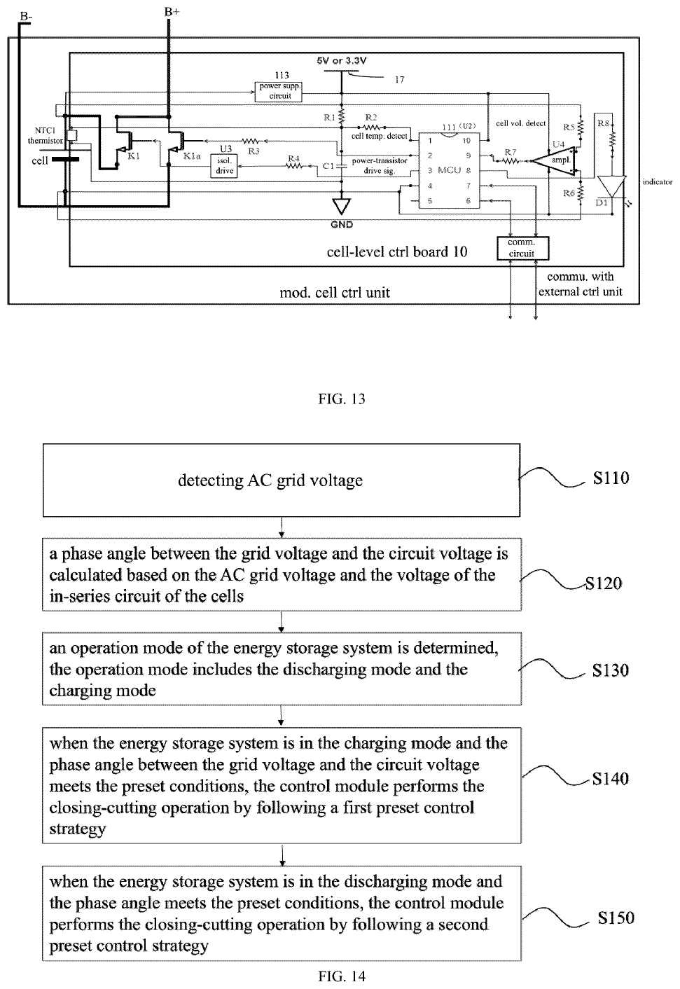

FIG. 13 is a circuit diagram of the modularized cell control unit according to some embodiments of the present disclosure. As shown in FIG. 13, the temperature detection circuit includes: a negative temperature coefficient (NTC) thermistor, a first resistor R1, a second resistor R2, and a first capacitor C1. A first end of the NTC thermistor is connected to a first end of the first resistor R1 and a first end of the second resistor R2. A second end of the first resistor R1 is connected to the power supply circuit 113. A second end of the second resistor R2 is connected to the first end 1 of the cell sampling chip 111. The first capacitor C1 is connected between the second end 2 and the third end 3 of the cell sampling chip 111. A second end of the NTC thermistor is connected to a second end of the first capacitor C1 and is then grounded GND.

Specifically, the NTC thermistor is attached to the cell. The NTC thermistor, the first resistor R1, the second resistor R2, the first capacitor C1, and the power supply cooperatively form the temperature detection circuit, which collects the temperature of the cell and sends the temperature to the MCU.

A resistance value of the NTC thermistor decreases as the temperature increases.

As shown in FIG. 13, the cell voltage detection circuit includes: an operational amplifier U4, a fifth resistor R5, a sixth resistor R6, and a seventh resistor R7. A first end of the operational amplifier U4 is connected to a first end of the seventh resistor R7. A second end of the seventh resistor R7 is connected to a ninth end 9 of the cell sampling chip 111. A second end of the operational amplifier U4 is connected to a first end of the fifth resistor R5. A second end of the fifth resistor R5 is connected to the positive electrode of the cell. A third end 3 of the operational amplifier U4 is connected to a first end of the sixth resistor R6. A second end of the sixth resistor R6 is connected to the negative electrode of the cell.

Specifically, the operational amplifier U4, the fifth resistor R5, the sixth resistor R6, and the seventh resistor R7 cooperatively form the cell voltage detection circuit, which collects the voltage of the cell and sends the voltage to the MCU.

As shown in FIG. 13, the indication circuit includes: an eighth resistor R8 and a light-emitting diode D1. A first end of the eighth resistor R8 is connected to an eighth end 8 of the cell sampling chip 111. A second end of the eighth resistor R2 is connected to an anode of the light-emitting diode D1. A cathode of the light-emitting diode D1 is connected to a fourth end 4 of the cell sampling chip 111.

Specifically, the light-emitting diode D1 is configured to indicate the operation state of the modularized cell control unit. When the light-emitting diode D1 is emitting light, it is indicated that the modularized cell control unit is operating normally. When the light-emitting diode D1 is flashing, it is indicated that the modularized cell control unit is malfunctioning.

Further, as shown in FIG. 13, the modularized cell control unit further includes: an isolation drive, a third resistor R3, and a fourth resistor R4. A first end of the isolation drive is connected to a control end of the first switch K1, a second end of the isolation drive is connected to a first end of the fourth resistor R4. A second end of the fourth resistor R4 is connected to the third end 3 of the cell sampling chip 111. A first end of the third resistor R3 is connected to the control end of the second switch K1a. A second end of the third resistor R3 is connected to the second end 2 of the cell sampling chip 111.

In some embodiments, the isolation drive includes a transformer or an optocoupler.

Specifically, a high-voltage portion of the circuit includes the cell, and a low-voltage portion of the circuit includes the cell sampling chip. Therefore, the isolation drive needs to be disposed between the high-voltage portion and the low-voltage portion. The transformer or the optocoupler is configured to isolate the control circuit from the main circuit, preventing strong electricity in the main circuit from interfering with weak electrical signals in the control circuit. Optocoupler isolation is substantially configured to prevent interference caused by electrical connections, especially the interference between the low voltage control circuit and the external high voltage circuit. Transformer isolation is substantially configured to isolate dangerous voltages to ensure the circuit to operate safely.

FIG. 14 is a flow chart of a control method of the energy storage system according to some embodiments of the present disclosure. The present disclosure provides a control method of the energy storage system. The control method includes the following operations.

In an operation S110, an AC grid voltage is detected.

In an operation S120, a phase angle between the grid voltage and the circuit voltage is calculated based on the AC grid voltage and the voltage of the in-series circuit of the cells.

In an operation S130, an operation mode of the energy storage system is determined, the operation mode includes the discharging mode and the charging mode.

In an operation S140, when the energy storage system is in the charging mode and the phase angle between the grid voltage and the circuit voltage meets the preset conditions, the control module performs the closing-cutting operation by following a first preset control strategy.

In an operation S150, when the energy storage system is in the discharging mode and the phase angle meets the preset conditions, the control module performs the closing-cutting operation by following a second preset control strategy.

Specifically, a power demand command from the user is received. The power demand command may be the active power P & the reactive power Q; or may be the active power P & the power factor. The modularized cell control unit detects the voltage and the temperature of the cell and uploads the voltage and the temperature to the control module. The grid voltage Vs is detected, and the magnitude and the phase are calculated. The amplitude and the phase angle δ of the voltage Vi of the series circuit of the cells are calculated by following: P=3Vs×Vi×sin δ/jWL; Q=3Vs×(Vs−Vi×conδ/jWL). The phase angle δ is the angle between the grid voltage Vs and the voltage Vi of the series circuit. The sinusoidal half-wave of the Vi is divided into 288 equal parts, and the peak voltage at the time point of nT is Vi×sin(180×nT/288). When the grid voltage Vs and phase angle δ meet preset conditions, the closing-cutting operation is performed on the modularized cell control units. A sum of voltages of the modularized cell control units that are closed-cut needs to be close to Vi×sin(180×nT/288).

When the energy storage system is in the charging mode, the control module ranks voltages of the modularized cell control units from a low value to a high value. When the grid voltage Vs and the phase angle & meet preset conditions, the modularized cell units are closed and cut. The voltages are added up from the low voltage to the high voltage, until the sum that is approximately equal to Vi×sin(180×nT/288) is obtained. Furthermore, the modularized cells are closed and cut into the circuit.

When the energy storage system is in the discharging mode, the control module ranks voltages of the modularized cell control units from the high value to the low value. When the grid voltage Vs and the phase angle & meet preset conditions, the modularized cell units are closed and cut. The voltages are added up from the high voltage to the low voltage, until the sum that is approximately equal to Vi×sin(180×nT/288) is obtained. Furthermore, the modularized cells are closed and cut into the circuit.

The control method of the energy storage system provided in the present embodiment is applied to the control circuit of the energy storage system, similar technical principles are applied, and similar technical effects are generated, which will not be repeated herein.

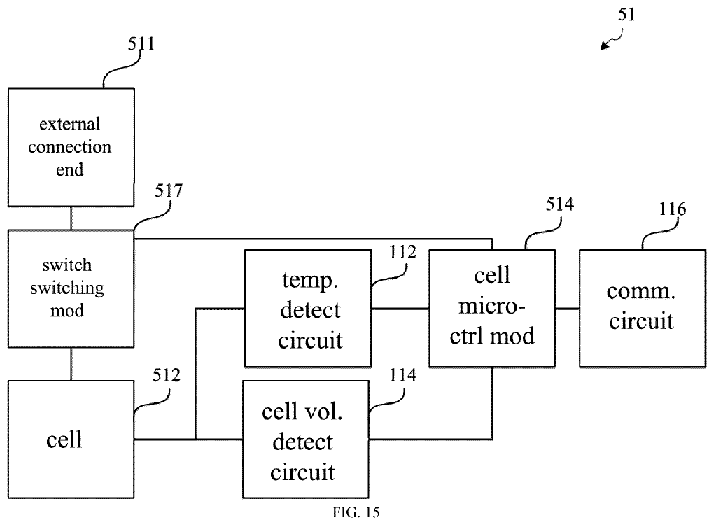

FIG. 15 is a structural schematic view of the energy storage system according to some embodiments of the present disclosure. As shown in FIG. 15, the energy storage system includes: an n-stage in-series-connected modularized cell control unit 51. The modular cell control unit 51 includes an external connection end 511, a cell 512, a temperature detection circuit 112, a cell micro-control module 514, a cell voltage detection circuit 114, a communication circuit 116, and a switch switching module 517. The n is a positive integer.

The cell 512 is electrically connected to the external connection end 511 via the switch switching module 517. The switch switching module 517 is configured to control whether the cell 512 is connected to the energy storage system.

The temperature detection circuit 112 is electrically connected to the cell micro-control module 514. The temperature detection circuit 112 is configured to detect the temperature of the cell 512 and to send the temperature to the cell micro-control module 514.

The cell voltage detection circuit 114 is connected in series between the cell 512 and the cell micro-control module 514. The cell voltage detection circuit 114 is configured to detect the voltage of the cell 512 and to send the voltage to the cell micro-control module 514.

The communication circuit 116 is communicatively connected to the cell micro-control module 514. The communication circuit 116 is configured to perform information interaction between the modularized cell control unit 51 and a superior control unit. The cell micro-control module 514 is further electrically connected to the switch switching module 517. The cell micro-control module 514 is configured to control the switch switching module 517 based on the temperature, the voltage and/or the information interaction with the superior control unit.

The communication circuit 116 may include the optic fiber terminal and the optic fiber communication chip. Specifically, an operation principle of the modularized cell control unit 51 is as follows. The temperature detection circuit 112 detects the temperature of the cell 512 and sends the temperature to the cell micro-control module 514. The cell voltage detection circuit 114 detects the voltage of the cell 512 and sends the voltage to the cell micro-control module 514. The cell micro-control module 514 uploads, through the communication circuit 116, the received temperature and voltage of the cell 512 to the superior control unit. The superior control unit sends commands to the cell micro-control module 514 through the communication circuit 116, based on the information of each module and the state of the power grid, and based on a preset control strategy. The cell micro-control module 514 receives the commands, and controls, according to the commands, the switch switching module 517 to perform a corresponding operation to control the cell 512 to be connected in series in the energy storage system or to be disconnected from the energy storage system.

In the present disclosure, the modularized cell control unit 51 is arranged. The temperature detection circuit 112 is configured to detect the temperature of the cell 512, and the voltage detection circuit 114 is configured to detect the voltage of the cell 512. The temperature and the voltage are then sent to the cell micro-control module 514. The cell micro-control module 514 uploads the temperature and the voltage to the superior control unit via the communication circuit 116. The superior control unit sends commands to the cell micro-control module 514 based on the information of each module. The cell micro-control module 514 controls the switch switching module 517 based on the commands to control the cell 512 to be connected to the energy storage system or to be disconnected from the energy storage system. The present embodiment may modularize the control unit of the cell 512 to form the energy storage system without arranging the battery management system or the PCS. Therefore, the assembling can be performed easily, and costs may be reduced.

As shown in FIG. 13, on the basis of the above embodiments, in some embodiments, the external connection end 511 includes a positive-electrode connection end B+ and a negative-electrode connection end B−. The negative-electrode connection end B− is electrically connected to the negative electrode of the cell 512.

The switch switching module 517 includes the first switch K1 and the second switch K1a. The first switch K1 is connected in series between the positive electrode and the positive-electrode connection end B+ of the cell 512. The second switch K1a is connected in series between the positive-electrode connection end B+ and the negative-electrode connection end B−.

Further as shown in FIG. 13, on the basis of the above embodiments, in some embodiments, the first switch K1 and/or the second switch K1a includes a MOS transistor.

Specifically, the cell micro-control module 514 sends a drive signal according to the commands sent from the superior control unit to drive the MOS transistors in the first switch K1 and the second switch K1a to be switched off or switched on to further control the cell 512 to be connected to or disconnected from the energy storage system. For example, the MOS transistor in the first switch K1 is switched on, and the positive-electrode connection end B+ is connected to the positive electrode of the cell 512. The MOS transistor in the second switch K1a is switched off, the negative-electrode connection end B− is connected to the negative electrode of the cell 512, and in this case, the cell 512 is connected to the energy storage system. In another example, the MOS transistor in the first switch K1 is switched off, the positive-electrode connection end B+ is disconnected from the positive electrode of the cell 512. The MOS transistor in the second switch K1a is switched on, and the negative-electrode connection end B− is connected to the positive-electrode connection end B+. In this case, the cell 512 is disconnected from the energy storage system.

In the present embodiment, by arranging the first switch K1 and the second switch K1a in the switch switching module 517, the external connection end 511 may be connected to or disconnected from the positive electrode and the negative electrode of the cell 512 by switching on or switching off the MOS transistors. In this way, the cell 512 is controlled to be connected to or disconnected from the energy storage system, enabling the energy storage system to operate more conveniently.

As shown in FIG. 13, the power supply voltage source 17 provides, through the first resistor R1, a voltage to an NTC resistor NTC1. The NTC resistor NTC1 detects the temperature of the cell and sends, through the second resistor R2, the temperature to the cell micro-control module. The first capacitor C1 is configured to filter out high-frequency interference signals from a power source or inducted from the circuit board.

In the present embodiment, by arranging the NTC resistor NTC1, the first resistor R1, and the second resistor R2 in the temperature detection circuit 112, the temperature of the cell is detected and is sent to the cell micro-control module. In this way, the cell micro-control module and the superior control unit may control the cell based on the temperature. The first resistor R1 and the second resistor R2 may prevent the current in the circuit from being excessively large, improving the safety of the energy storage system.

Further as shown in FIG. 13, in some embodiments, in addition to the above embodiments, the energy storage system further includes the following.

A power supply circuit 113 is arranged and is electrically connected to the cell. The power supply circuit 113 is configured to provide a power supply voltage to the modularized cell control unit.

Specifically, the power supply circuit 113 takes power directly from the cell and converts the power to a voltage required by the modularized cell control unit. Exemplarily, the voltage required by the modularized cell control unit may be 5V or 3.3V.

In the present embodiment, the power supply circuit 113 provides power to the modularized cell control unit. In this way, since because the power supply circuit 113 has a simple structure and a flexible design, the modularized cell control unit may be assembled and operate easily.

As shown in FIG. 13, in some embodiments, in addition to the above embodiments, the cell micro-control module includes the micro-control chip U2, the isolation driving circuit U3, the third resistor R3, and the fourth resistor R4. In an embodiment, the micro-control chip U2 is the same as the cell sampling chip 111 as described in the above.

The micro-control chip U2 includes a first drive signal pin and a second drive signal pin. The third resistor R3 is connected in series between the first drive signal pin and the control end of the second switch K1a. The isolation driving circuit U3 and the fourth resistor R4 are connected in series between the second drive signal pin and the control end of the first switch K1.

Specifically, the micro-control chip U2 outputs the first drive signal through the first drive signal pin to drive the second switch K1a to be switched on or switched off. The micro-control chip U2 outputs a second drive signal through the second drive signal pin to drive the first switch K1 to be switched on or switched off. Since the MOS transistors in the first switch K1 and the second switch K1a have a high operating frequency and a high input impedance, the MOS transistors may be easily interfered. Therefore, the isolation driving circuit U3 is arranged to achieve isolation between the main circuit and the control circuit, enabling the MOS transistors to have a high anti-interference capability, and preventing the power-level circuit from interfering with the control signal. The third resistor R3 and the fourth resistor R4 are configured to prevent the current from being excessively large to damage the circuit.

In the present embodiment, by arranging the micro-control chip U2, the isolation driving circuit U3, the third resistor R3 and the fourth resistor R4 in the cell micro-control module, the first switch K1 and the second switch K1a may be controlled. In this way, the chip is safely and effectively controlled to be connected to or disconnected from the energy storage system, such that the module can be assembled and operate easily.

As shown in FIG. 13, the cell voltage detection circuit includes the operational amplifier U4, the fifth resistor R5, the sixth resistor R6, and the seventh resistor R7. A voltage signal at the positive electrode of the cell is input into the operational amplifier U4 through the fifth resistor R5. A voltage signal at the negative electrode of the cell is input into the operational amplifier U4 through the sixth resistor R6. In this way, a voltage difference is generated, i.e., voltages at the two ends of the cell. The voltage is amplified by the operational amplifier U4 and is input, through the seventh resistor R7, to the cell micro-control module.

In the present embodiment, by arranging the operational amplifier U4, the fifth resistor R5, the sixth resistor R6, and the seventh resistor R7 in the cell voltage detection circuit 114, the voltage of the cell is detected and sent to the cell micro-control module. In this way, the cell micro-control module and the superior control unit may control the cell based on the voltage. The fifth resistor R5, the sixth resistor R6, and the seventh resistor R7 are configured to prevent the current in the circuit from being excessively large to damage the operational amplifier U4, such that the safety of the energy storage system is improved.

Further as shown in FIG. 13, in some embodiments, in addition to the above embodiments, the energy storage system further includes: an eighth resistor R8 and an indicator light module D1. The eighth resistor R8 and the indicator light module D1 are connected in series between the cell micro-control module and a ground end. The indicator light module D1 is configured to indicate a state of the modularized cell control unit.

The indicator light module D1 may include a light-emitting diode or an incandescent lamp.

Specifically, the cell micro-control module controls the indicator light module D1 based on the temperature and the voltage of the cell to indicate the operation state of the modularized cell control unit. Exemplarily, when the indicator light is emitting light, the modularized cell control unit operates normally. When the indicator light is flashing, the modularized cell control unit is malfunctioning. The eighth resistor R8 is configured to prevent the current from being excessively large.

In the present embodiment, the eighth resistor R8 and the indicator module D1 are arranged to indicate the operation state of the modularized cell control unit, the structure is simple, and the user may easily understand the operation state of each modularized cell control unit. When a fault occurs, the user is enabled to discover the failed structure in time, allowing the failed structure to be found and fixed.

In addition to the above embodiments, the temperature detection circuit 112, the cell micro-control module 514, the cell voltage detection circuit 114, the communication circuit 116, and the switch switching module 517 are arranged on the cell-level control board 10.

Specifically, the temperature detection circuit 112, the cell micro-control module 514, the cell voltage detection circuit 114, the communication circuit 116, and the switch switching module 517 are integrated in the cell-level control board 10. In this way, the circuit design is simplified, a size of the circuit is reduced, and costs are reduced. According to the actual situation, the cell-level control board 10 may be arranged on a side or a front of the cell, the cell-level control board 10 and the cell may be integrated to form a one-piece structure, such that the cell control unit is modularized.

In the present embodiment, by arranging the cell-level control board 10, the temperature detection circuit 112, the cell micro-control module 514, the cell voltage detection circuit 114, the communication circuit 116, and the switch switching module 517 are integrated into the cell-level control board 10. In this way, the size of the circuit is reduced, and costs are effectively reduced. Moreover, the cell-level control board 10 and the cell form an integrated and one-piece structure, and the energy storage system can be assembled and operate more conveniently.

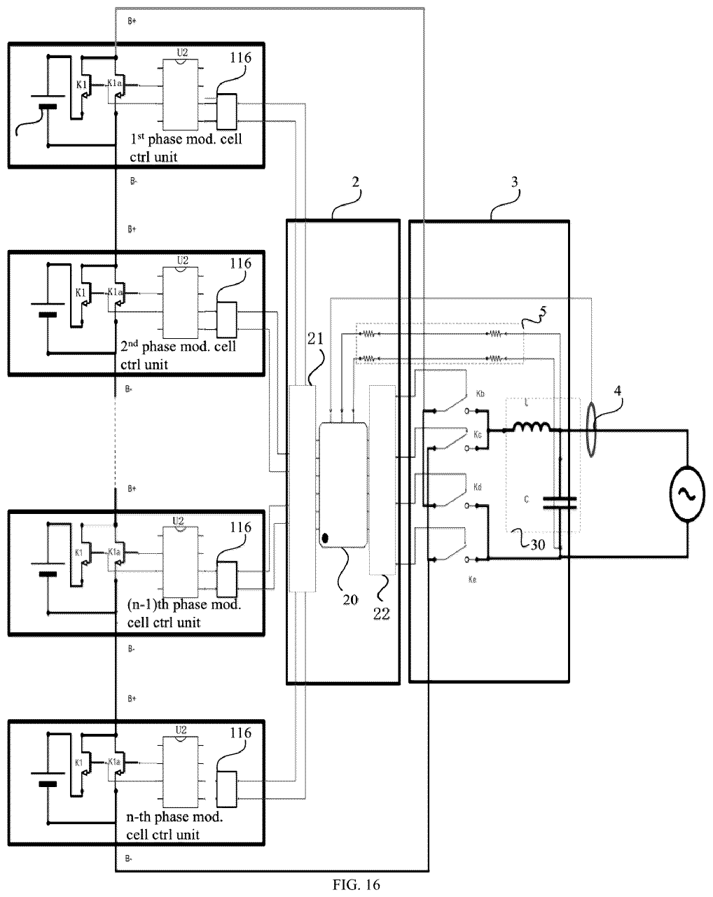

FIG. 16 is a structural schematic view of another energy storage system according to some embodiments of the present disclosure. As shown in FIG. 16, in addition to the above embodiments, the energy storage system further includes the following.

A superior control unit 2 is arranged.

A commutation module 3 includes a first commutating switch Kb, a second commutating switch Kc, a third commutating switch Kd, a fourth commutating switch Ke, and a filter unit 30. The filter unit 30 includes a filter input end, a filter output end, and a common end. The first commutating switch Kb is connected in series between the positive electrode of the modularized cell control unit 1 of a stage 1 and the filter input end. The second commutating switch Kc is connected in series between the negative electrode of the modularized cell control unit 1 of a stage n and the filter input end. The third commutating switch Kd is connected in series between the positive electrode of the modularized cell control unit 1 of the stage 1 and the common end. The fourth commutating switch Ke is connected in series between the negative electrode of the modularized cell control unit 1 of the stage n and the common end. The filter output end and the common end serve as an output end of the commutating module 3.

The superior control unit 2 is configured to control a state of each of the first commutating switch Kb, the second commutating switch Kc, the third commutating switch Kd and the fourth commutating switch Ke, so as to convert the DC of the modularized cell unit 1 to the AC.

In an embodiment, the superior control unit 2 is the same as the control module 20 described in the above.

As shown in FIG. 16, in some embodiments, the filter unit 30 includes a first filter inductor L and a first filter capacitor C.

As shown in FIG. 16, in some embodiments, the n-stage modularized cell control units are connected in series to form the modularized cell unit. A positive-electrode connection end B+ of the modularized cell control unit of the level 1 is electrically connected to the commutating module 3. A negative-electrode connection end B− of the modularized cell control unit of the level 1 is electrically connected to a positive-electrode connection end B+ of the modularized cell control unit of a level 2. For the remaining modularized cell control units, a positive-electrode connection end B+ of the modularized cell control unit of a certain level is connected to a negative-electrode connection end B− of the modularized cell control unit of a level prior to the certain level, successively. A negative-electrode connection end B− of the modularized cell control unit of the level n is electrically connected to the commutating module 3.

As shown in FIG. 16, in some embodiments, the superior control unit 2 includes a master control chip 20, a first communication unit 21 and a second communication unit 22.

Specifically, the superior control unit 2 interacts with the modularized cell control unit 1 via the first communication unit 21; and drives, via the second communication unit 22, the switches in the commutating module 3 to be switched on or off. The commutating module 3 is configured to commutate the half-wave sinusoidal voltage. The filter unit 30 is configured to smooth and filter the stepped waveform of the cell. The superior control unit 2 may further interact information with mobile devices via Bluetooth or 5G or a WIFI module. Exemplarily, the mobile devices may be a mobile phone or a computer, and so on.

When the energy storage system is connected to the grid, the number of modularized cell control units is limited by the voltage of the grid. Taking the grid having a voltage of 230V as an example, the number of modularized cell control units is n=230×1.1×1.414/2.5=144, and therefore, at least 144 modularized cell control units 1 are needed to be connected in series with each other to form the 230V grid system.

As shown in FIG. 16, in some embodiments, in addition to the above embodiments, the energy storage system further includes the following.

A current detection unit 4 is electrically connected to the superior control unit 2. The current detection unit 4 is configured to detect a current at the filter output end and send the current to the superior control unit 2.

A voltage sampling unit 5 is electrically connected to the superior control unit 2. The voltage sampling unit 5 is configured to detect a voltage at the output end of the commutating module 3 and send the voltage to the superior control unit 2.

Specifically, the voltage sampling unit 5 is configured to phase-lock the grid voltage. The current detection unit 4 is configured to detect the current of the system and disconnect the switches in the commutating module 3 when the current exceeds a preset threshold value.

An operation principle of the energy storage system in the present embodiment is as follows.

S110, the system is powered up.

S120, a power demand command is received from the user. The power demand command includes an active power command and a reactive power command; or includes an active power command and a power factor command.

S130, the modularized cell control unit 1 detects the voltage and the temperature of the cell and uploads the voltage and the temperature to the superior control unit 2.

S140, the grid voltage Vs is detected, and a amplitude and a phase of the grid voltage Vs are calculated.

S150, a amplitude and a phase angle δ of the series circuit voltage Vi of the n-stage modularized cell control unit 1 is calculated. The calculation is performed by following the following formula:

$$P = 3 Vs \times Vi \times sin δ / j ω L$$

$$Q = 3 Vs \times ( Vs - Vi \times cos δ ) / j ω L$$

The P denotes the active power, the Q denotes the reactive power, and the L denotes a filter inductance.

S160, a sinusoidal half-wave of the series circuit voltage Vi of the n-stage modularized cell control unit 1 is divided into 288 equal parts, and a peak voltage at the time point of nT is Vi×sin(180×nT/288).

S170, a closing-cutting operation is performed on the modularized cell control unit 1 when the phase angle δ of the grid voltage meets preset conditions. A sum of voltages of the closed-cut modularized cell control unit 1 needs to be close to the peak voltage.

In the present embodiment, by arranging the current detection unit 4 and the voltage sampling unit 5, the grid voltage and the output current at the filter output end are detected, such that voltage calculation is easily performed when the modularized cell control unit 1 is being closed-cut, and safety of the system circuit is improved.

In the present embodiment, the superior control unit 2 and the commutating module 3 are arranged to convert the DC of the modularized cell control unit to the AC. In the present embodiment, the PCS may be omitted, and that is, costs and the size of the system are reduced.

To be noted that, various closing-cutting algorithms for the modularized cell control unit are available. In an example, the closing-cutting algorithm is that, in the charging process, the cell having the low voltage is firstly charged; and in the discharging process, the cell having the high voltage is firstly discharged. However, the present disclosure is limited thereto.

In addition to the above embodiments, as shown in FIG. 5, the voltage waveform is commutated to be a complete sinusoidal waveform.

Exemplarily, in the charging mode, at the time point of 144T, the peak voltage Vp is: Vp=Vi×sin 90=Vi. Voltages of cells of the n-stage modularized cell control unit 1 are added up from a low voltage to a high voltage, until a sum of voltage of m cells is approximately equal to the peak voltage. The superior control unit 2 sends commands to the m modularized cell control units 1, which are involved in the sum calculation, to switch on the corresponding first switches K1 and switch off the corresponding second switches K1a. In this case, the m cells are connected in series to the energy storage system. In addition, the superior control unit 2 sends commands to the remaining n-m modularized cell control units 1 to switch off the corresponding first switches K1 and switch on the corresponding second switches K1a. In this case, the n-m cells are disconnected from the energy storage system. In this case, the voltage of the entire system circuit is about equal to Vi. In this way, one stepped sinusoidal half-wave is formed between the time point IT and the time point 288T. A commutating operation is performed on a second sinusoidal half-wave to obtain the stepped sinusoidal waveform. Furthermore, the stepped sinusoidal waveform is treated by the filter unit 30 to obtain a smooth sinusoidal wave.

As shown in FIG. 6, when the grid voltage has a phase angle δ=0 and the series circuit voltage Vi of the n-stage modularized cell control unit 1 is greater than the grid voltage Vs, the system is in the discharging mode, and a system output is purely an active output. As shown in FIG. 7, when the grid voltage has the phase angle δ=0 and the series circuit voltage Vi of the n-stage modularized cell control unit 1 is less than the grid voltage Vs, the system is in the charging mode, the system output is purely the active output. As shown in FIG. 8, when the grid voltage has a phase angle δ<0 and the series circuit voltage Vi of the n-stage modularized cell control unit 1 is greater than the grid voltage Vs, the system is in the discharging mode, and the system output is an active and inductive reactive output. As shown in FIG. 9, when the grid voltage has a phase angle δ>0 and the series circuit voltage Vi of the n-stage modularized cell control unit 1 is greater than the grid voltage Vs, the system is in the discharging mode, and the system output is an active and capacitive reactive output.

To be noted that, the operation mode of the energy storage system and the type of the reactive output may be determined according to the demands. The operation mode of the energy storage system includes a rectifier mode and an inversion mode. The type of the reactive output from the energy storage system includes the inductive reactive power and the capacitive reactive power.

An operating principle of bypassing a failed cell is as follows. When one cell fails, the corresponding cell micro-control module 14 switches off the corresponding first switch K1 of the modularized cell control unit 1, and switches on the corresponding second switch K1a of the modularized cell control unit 1. In this way, the failed cell is bypassed, and the normal operation of the system is not affected. In this case, the cell micro-control module 14 controls the indicator module D1 to flash to indicate that the corresponding modularized cell control unit 1 is failed.

In the present embodiment, in the closing-cutting algorithm, the cell having the low voltage is firstly charged during the charging process, and the cell having the high voltage is firstly discharged during the discharging process, such that the battery management system is not needed to control the cell, and costs of the energy storage system is reduced. Furthermore, when a single cell is failed, the cell micro-control module 14 controls the first switch K1 of the modularized cell control unit 1 to be switched off and controls the second switch K1a of the modularized cell control unit 1 to be switched on. Furthermore, the cell micro-control module 14 controls the indicator module D1 to send a reminder to the user. In this way, normal operation of the system is affected, and system failures can be found and solved quickly.

As shown in FIG. 10, the energy storage system outputs three-phase alternating currents.

The n-stage in-series modularized cell control unit 1, the superior control unit 2 and the commutating module 3 are connected to each other to form a one-phase AC output module of the energy storage system.

ACs output from the three-phase AC output module have a phase angle of 120 degrees between every two ACs.

As shown in FIG. 10, in some embodiments, the superior control unit 2 further includes a third communication unit 23.

The three-phase AC output module is the A-phase AC output module, the B-phase AC output module, and the C-phase AC output module.

Specifically, zero wires N of AC output modules of all phases are connected to each other. The fire wire L of the AC output module of each phase is correspondingly connected to the three-phase fire wires (R wire, S wire, and L wire) of the three-phase grid. The superior control unit 2 in the A-phase AC output module serves as the master control unit and communicates with the AC output modules of the other two phases through the third communication unit 23 to control the AC output modules of the other two phases to have a phase angle of 120 degrees successively.

In the present embodiment, the n-stage in-series modularized cell control unit 1, the superior control unit 2 and the commutating module 3 are connected to each other to form a one-phase AC output module of the energy storage system. The energy storage system outputs three-phase ACs to connect to the power grid. In the present embodiment, the energy storage system that have three-phase outputs can be formed by omitting the battery management system and the PCS. The energy storage system can be assembled and operate easily, and costs of the energy storage system are reduced.

What is claimed is:

1. A control circuit of an energy storage system, comprising: a cell module, a control module, and a commutating module, wherein, the cell module, the control module and the commutating module are connected in sequence;
the cell module comprises n modularized cell control units, each modularized cell control unit comprises a cell, a first switch and a second switch; the cell and the first switch are connected to each other in series, and are further connected in parallel to the second switch; the n is a positive integer;
a first switch and a second switch of a first modularized cell control unit of the n modularized cell control units are connected to each other to serve as a first end of the cell module; a first switch and a second switch of an n-th modularized cell control unit of the n modularized cell control units are connected to each other to serve as a second end of the cell module;
the commutating module comprises a first commutating switch, a second commutating switch, a third commutating switch, a fourth commutating switch and a filter unit; the filter unit comprises a first end, a second end and a third end; the first end of the cell module is connected with a first end of the first commutating switch and a first end of the third commutating switch; a second end of the first commutating switch is connected with the first end of the filter unit; a second end of the third commutation switch is connected to the third end of the filter unit; the second end of the cell module is connected to a first end of the second commutating switch and a first end of the fourth commutating switch; the second commutating switch is connected to the first end of the filter unit; a second end of the fourth commutating switch is connected to the third end of the filter unit; an alternating current (AC) grid is connected between the second end of the filter unit and the third end of the filter unit; and
the control module is communicatively connected to the modularized cell control units and the commutating module; the control module is configured to control the first commutating switch, the second commutating switch, the third commutating switch and the fourth commutating switch to be switched on or switched off.

2. The control circuit according to claim 1, wherein, the modularized cell control unit further comprises a cell sampling chip, and the control module further comprises a master controller;
the cell sampling chip is communicatively connected to n cells of the n modularized cell control units and the master controller, the cell sampling chip is configured to collect a voltage and a temperature of each of the n cells and send the voltage and the temperature to the master controller;
the master controller is communicatively connected with the first commutating switch, the second commutating switch, the third commutating switch and the fourth commutating switch; the master controller is configured to analyze and calculate the received voltage and temperature and to control n first switches of the n modularized cell control units, n second switches of the n modularized cell control units, the first commutating switch, the second commutating switch, the third commutating switch and the fourth commutating switch to be switched on or switched off.

3. The control circuit according to claim 2, wherein, the commutating module further comprises a voltage sampling unit and a current detection unit;
a first end of the voltage sampling unit is connected to an eleventh of the master controller, a second end of the voltage sampling unit is connected to a tenth of the master controller; a third end of the voltage sampling unit is connected to the second end of the filter unit, a fourth end of the voltage sampling unit is connected to the second third of the filter unit;
a first end of the current detection unit is connected to a twelfth end of the master controller, a second end of the current detection unit is connected to the second end of the filter unit.

4. The control circuit according to claim 2, wherein, the modularized cell control unit further comprises: a temperature detection circuit, a power supply circuit, a cell voltage detection circuit, an indication circuit, and a communication circuit;
a first end of the temperature detection circuit is connected to the power supply circuit, a second end of the temperature detection circuit is connected to a first end of the cell sampling chip, a third end of the temperature detection circuit is connected to a second end of the cell sampling chip, a fourth end of the temperature detection circuit is connected to a third end of the cell sampling chip, a fifth end of the temperature detection circuit is grounded; and
a first end of the power supply circuit is connected to a positive electrode of the cell, and a second end of the power supply circuit is connected to the cell voltage detection circuit;
a first end of the cell voltage detection circuit is connected to a ninth end of the cell sampling chip, a second end of the cell voltage detection circuit is connected to a positive electrode of the cell, a third end of the cell voltage detection circuit is connected to a negative electrode of the cell;
a first end of the indication circuit is connected to an eighth end of the cell sampling chip, and a second end of the indication circuit is connected to a fourth end of the cell sampling chip;
a first end of the communication circuit is connected to a sixth end and a seventh end of the cell sampling chip, and a second end of the communication circuit is communicatively connected to an external control unit.

5. The control circuit according to claim 4, wherein, the temperature detection circuit comprises: a negative temperature coefficient (NTC) thermistor, a first resistor, a second resistor, and a first capacitor;
a first end of the NTC thermistor is connected to a first end of the first resistor and a first end of the second resistor, a second end of the first resistor is connected to the power supply circuit, a second end of the second resistor is connected to the first end of the cell sampling chip, the first capacitor is connected between the second end of the cell sampling chip and the third end of the cell sampling chip, a second end of the NTC thermistor is connected to a second end of the first capacitor and is further grounded.

6. The control circuit according to claim 4, wherein, the cell voltage detection circuit comprises: an operational amplifier, a fifth resistor, a sixth resistor and a seventh resistor;
a first end of the operational amplifier is connected to a first end of the seventh resistor, a second end of the seventh resistor is connected to the ninth end of the cell sampling chip, a second end of the operational amplifier is connected to a first end of the fifth resistor, a second end of the fifth resistor is connected to the positive electrode of the cell, a third end of the operational amplifier is connected to a first end of the sixth resistor, a sixth resistor is second end is connected to the negative electrode of the cell.

7. The control circuit according to claim 4, wherein, the indication circuit comprises: an eighth resistor and a light-emitting diode; a first end of the eighth resistor is connected to the eighth end of the cell sampling chip, a second end of the eighth resistor is connected to an anode of the light-emitting diode, and a cathode of the light-emitting diode is connected to a fourth end of the cell sampling chip.

8. The control circuit according to claim 4, wherein, the modularized cell control unit further comprises: an isolation drive, a third resistor and a fourth resistor;
a first end of the isolation drive is connected to a control end of the first switch, a second end of the isolation drive is connected to a first end of the fourth resistor, a second end of the fourth resistor is connected to a third end of the cell sampling chip, a first end of the third resistor is connected to a control end of the second switch, a second end of the third resistor is connected to the second end of the cell sampling chip.

9. The control circuit according to claim 8, wherein, the isolation driver comprises a transformer or an optocoupler.

10. The control circuit according to claim 1, wherein, the control module is configured to interact information with an external mobile device by Bluetooth, 5G or WIFI.

11. A control method of an energy storage system, comprising:
detecting a voltage of an alternating current (AC) grid;
calculating, based on the voltage of the AC grid and a voltage of a series circuit of cells, a phase angle between the grid voltage and a circuit voltage;
determining an operation mode of the energy storage system, wherein the operation mode comprises a discharging mode and a charging mode;
performing, by a control module, a closing-cutting operation by following a first preset control strategy, in response to the energy storage system being in the charging mode and the phase angle between the grid voltage and the circuit voltage meeting a preset condition; and
performing, by the control module, the closing-cutting operation by following a second preset control strategy, in response to the energy storage system being in the discharging mode and the phase angle between the grid voltage and the circuit voltage meeting the preset condition.

12. An energy storage system, comprising:
an n-stage in-series-connected modularized cell control unit, wherein, the modularized cell control unit comprises an external connection end, a cell, a temperature detection circuit, a cell micro-control module, a cell voltage detection circuit, a communication circuit, and a switch switching module; and the n is a positive integer;
wherein, the cell is electrically connected to the external connection end via the switch switching module; the switch switching module is configured to control the cell to be connected to or disconnected from the energy storage system;
the temperature detection circuit is electrically connected to the cell and the cell micro-control module, the temperature detection circuit is configured to detect a temperature of the cell and to send the temperature to the cell micro-control module;
the cell voltage detection circuit is connected in series between the cell and the cell micro-control module, the cell voltage detection circuit is configured to detect a voltage of the cell and to send the voltage to the cell micro-control module;
the communication circuit is communicatively connected to the cell micro-control module, the communication circuit is configured to perform information interaction between the modularized cell control unit and a superior control unit;
the cell micro-control module is further electrically connected to the switch switching module, the cell micro-control module is configured to control the switch switching module based on the temperature, the voltage and/or the information interacted with the superior control unit.

13. The energy storage system according to claim 12, wherein, the external connection end comprises a positive-electrode connection end and a negative-electrode connection end, the negative-electrode connection end is electrically connected to a negative electrode of the cell;
the switch switching module comprises a first switch and a second switch, the first switch is connected in series between the positive electrode of the cell and the positive-electrode connection end, the second switch is connected in series between the positive-electrode connection end and the negative-electrode connection end.

14. The energy storage system according to claim 12, wherein, the temperature detection circuit comprises: a negative temperature coefficient (NTC) thermistor, a first resistor, a second resistor, and a first capacitor; a first end of the NTC thermistor is connected to a first end of the first resistor, a second end of the first resistor is connected to a power supply circuit;
a first end of the second resistor is electrically connected to the first end of the first resistor, a second end of the second resistor is electrically connected to the cell micro-control module; the first capacitor is electrically connected to the first end of the first resistor, the first capacitor is electrically connected to the second end of the NTC resistor, the second end of the NTC resistor is grounded.

15. The energy storage system according to claim 13, wherein, the cell micro-control module comprises a micro-control chip, an isolation driving circuit, a third resistor, and a fourth resistor;
the micro-control chip comprises a first drive signal pin and a second drive signal pin, the third resistor is connected in series between the first drive signal pin and a control end of the second switch, the isolation driving circuit and the fourth resistor are connected in series between the second drive signal pin and a control end of the first switch.

16. The energy storage system according to claim 13, wherein, the cell voltage detection circuit comprises an operational amplifier, a fifth resistor, a sixth resistor, and a seventh resistor;
the fifth resistor is connected in series between the positive electrode of the cell and a first input end of the operational amplifier, the sixth resistor is connected in series between the negative electrode of the cell and a second input end of the operational amplifier, and the seventh resistor is connected in series between an output end of the operational amplifier and the cell micro-control module.

17. The energy storage system according to claim 12, further comprising: a cell-level control board;
wherein, the temperature detection circuit, the cell micro-control module, the cell voltage detection circuit, the communication circuit and the switch switching module are arranged on the cell-level control board.

18. The energy storage system according to claim 12, further comprising:
a superior control unit;
a commutation module, comprising: a first commutating switch, a second commutating switch, a third commutating switch, a fourth commutating switch, and a filter unit; wherein, the filter unit comprises a filter input end, a filter output end, and a common end; the first commutating switch is connected in series between a positive electrode of a modularized cell control unit of a stage 1 and the filter input end; the second commutating switch is connected in series between a negative electrode of the modularized cell control unit of a stage n and the filter input end; the third commutating switch is connected in series between the positive electrode of the modularized cell control unit of the stage 1 and the common end; the fourth commutating switch is connected in series between the negative electrode of the modularized cell control unit of the stage n and the common end; and the filter output end and the common end serve as an output end of the commutating module;
wherein, the superior control unit is configured to control a state of each of the first commutating switch, the second commutating switch, the third commutating switch and the fourth commutating switch, so as to convert a direct current of the modularized cell unit to an alternating current.

19. The energy storage system according to claim 18, further comprising:
a current detection unit, electrically connected to the superior control unit; wherein, the current detection unit is configured to detect a current at the filter output end and send the current to the superior control unit; and
a voltage sampling unit, electrically connected to the superior control unit, wherein, the voltage sampling unit is configured to detect a voltage at the output end of the commutating module and send the voltage to the superior control unit.

20. The energy storage system according to claim 18, wherein, the energy storage system is configured to output three-phase alternating currents;
the n-stage in-series-connected modularized cell control unit, the superior control unit, and the commutating module form a one-phase alternating current output module of the energy storage system; and
alternating currents output from every two phases of a three-phase alternating current output module have a phase angle of 120 degrees.
